(19) United States
(12) Patent Application Publication
(10) Pub. No.: US 2026/0126801 A1
(43) Pub. Date: May 7, 2026

(54) SYSTEM AND METHOD FOR GENERATING A COVERAGE PATH PLANNING FOR AUTONOMOUS UNDERWATER VEHICLES

(71) Applicant: International Institute of Information Technology, Hyderabad, Hyderabad (IN)

(72) Inventors: Kamalakar Karlapalem, Hyderabad (IN); Charu Sharma, Hyderabad (IN); Nikhil Chandak, Kolkata (IN)

(21) Appl. No.: 19/298,464

(22) Filed: Aug. 13, 2025

(30) Foreign Application Priority Data
Nov. 5, 2024 (IN) 202441084478

(51) Int. Cl. G05D 1/46; G01C 21/20; G01S 15/89

(52) U.S. Cl. CPC G05D 1/46; G01C 21/203; G01S 15/8902

(57) ABSTRACT

The invention relates to a method for generating a coverage path planning (CPP) for Autonomous underwater vehicles (AUVs) with nadir gaps. The method includes (i) receiving an area of interest, a count of the AUVs, a respective starting point of the AUVs, and an operational constraint from a user through a user device, (ii) generating a path with a nadir gap based on the area of interest using a pair of lines method, (iii) determining a path planning method from one or more path planning methods based on an operational priority and the starting point of the AUVs, and (iv) dividing the path into a plurality of segments by applying the determined path planning method on the path based on the starting point of the AUVs, thereby each segment is assigned to each AUV.

### BACKGROUND

### Technical Field

The embodiments herein gradually relate to autonomous underwater vehicles (AUVs) and their application in underwater surveillance, exploration, and environmental monitoring, specifically, to coverage path planning (CPP) methods and systems designed to manage and optimize the coordinated movement of multiple AUVs to achieve full area coverage in underwater environments, particularly in the presence of nadir gaps where sensing coverage is limited or partial.

### Description of the Related Art

In recent years, autonomous underwater vehicles (AUVs) have become essential tools in underwater surveillance, exploration, and environmental monitoring. These vehicles offer an efficient, cost-effective, and safe means to gather data from marine environments, which are often difficult and hazardous for human divers to access. A key challenge in these applications is Coverage Path Planning (CPP), where the objective is to ensure that the entire area of interest is surveyed without gaps, in a time-efficient manner. This challenge becomes particularly pronounced in the presence of nadir gaps, which are blind zones directly beneath the AUVs where sensor coverage is lacking.

Traditionally, CPP has been extensively studied for single AUV operations. Various strategies have been proposed to mitigate nadir gaps during single-AUV missions, such as the “Pair of Lines” method. However, the rapid advancement of AUV technology has led to the deployment of multiple AUVs in coordinated missions, which offers the potential to significantly improve coverage efficiency and reduce mission time. Despite this, there has been a lack of solutions specifically addressing CPP for multi-AUV operations, particularly in the presence of nadir gaps.

Multi-AUV CPP introduces additional challenges, such as the need for efficient collaboration between vehicles to ensure complete coverage while minimizing the likelihood of collisions. Furthermore, the optimization of secondary objectives, such as minimizing the maximum distance travelled by any AUV and reducing the total number of turns, becomes critical in such missions. Each of these objectives is associated with trade-offs that must be carefully balanced

Therefore, there arises a need to address the aforementioned technical drawbacks for a system to generate CPP for AUVs in underwater surveillance missions, accounting for nadir gaps.

### SUMMARY

In view of the foregoing, an embodiment herein provides a method for generating a coverage path planning (CPP) for a plurality of Autonomous underwater vehicles (AUVs) with nadir gaps. The method includes receiving input from a user through a user device that is communicatively connected to the central server through a network. The input includes an area of interest, a count of the plurality of AUVs, a respective starting point of the plurality of AUVs, and an operational constraint. The method includes generating a path with a nadir gap based on the area of interest, using a pair of lines method. The path includes a plurality of waypoints on a two-dimensional (2D) plane. The method includes determining a path planning method from a plurality of path planning methods based on an operational priority and the starting point of the plurality of AUVs. The method includes generating the CPP for the plurality of AUVs by dividing the path into a plurality of segments by applying the determined path planning method on the path based on the starting point of the plurality of AUVs, thereby each segment is assigned to each AUV. The method includes transmitting the generated CPP to the plurality of AUVs that are communicatively connected to the central server through the network.

In some embodiments, the operational constraint includes minimizing a maximum distance travelled by at least one of the plurality of AUVs or minimizing a total number of turns executed by any one of the plurality of AUVs.

In some embodiments, the plurality of path planning methods includes a partition zigzag method and a turn-aware zigzag method.

In some embodiments, the partition zigzag method iteratively assigns the segments of the path P to each AUV by (i) identifying a first highest index j₁≤L for a first AUV when a total distance travelled by the first AUV from a first starting point S₁ to first waypoint P₁, traversing intermediate waypoints, and returning to the first starting point S₁ is less than or equal to a threshold distance (x) S₁ is ≤x, (ii) identifying a second highest index for a second AUV when a total distance travelled by the second AUV from the second starting point and returning to the second starting point is less than or equal to the threshold distance, (iii) repeating the process for each subsequent AUV, determining the highest index jᵢ for each AUV i starting from j₍ᵢ₋₁₎, such that the AUV travels at most distance or the threshold distance x before returning to its starting position Sᵢ, (iv) maintaining a running sum of distances at each waypoint to enable efficient computation of partitioning indices, (v) applying a boolean step function on the path obtained from the pair of lines method based on the highest indices j₁,j₂, . . . ,j_{N} identified for each AUV to evaluate whether a sum of the distances travelled by the plurality of AUVs, is equal to the total distance of the path generated for the plurality of AUVs, (vi) assigning the highest indices to the corresponding AUVs if the sum of the distance travelled by the plurality of AUVs is equal to the total distance of the path, and (vii) iteratively assigning waypoints to each AUV using: (a) an initial index j₀=1 for the first AUV, (b) computing distance constraints to determine jᵢ for each AUV i, (c) verifying whether all waypoints are covered using the function f(x). The Boolean step function f(x) determines whether the path P can be divided into N parts such that each AUV travels the threshold distance from and returning to its deployment location. The first highest index is a second starting point. The highest index for the AUV is the furthest point in its path that the AUV reaches before returning to its starting point,

In some embodiments, the partition zigzag method includes (i) performing a binary search on the boolean step function f(x) to obtain an optimal threshold distance if the sum of the highest indices identified for the plurality of AUVs is not equal to the total distance of the path generated using the pair of lines method, (ii) executing f(x*) to compute partition indices jᵢ and assigning final path segments to each AUV using the computed indices Pᵢ=[Sᵢ,pⱼ_{ᵢ₋₁},pⱼ_{ᵢ₋₁}₊₁,pⱼ_{ᵢ₋₁}₊₂, . . . ,pⱼ_{ᵢ},Sᵢ]. The method performs the binary search on the f(x) to determine the minimum value of x* for which the path can be partitioned into N part. Each AUV travels from its starting point Sᵢ to the waypoints pⱼ_{ᵢ₋₁},pⱼ_{ᵢ₋₁}₊₁,pⱼ_{ᵢ₋₁}₊₂, . . . ,pⱼ_{ᵢ}, and returns to Sᵢ.

In some embodiments, the partition zigzag method includes executing the boolean step function as binary search for finding the optimal threshold distance to compute optimal indices for each of the plurality of AUVs to assign respective segments to each AUV.

In some embodiments, the turn-aware zigzag method iteratively assigns the segments of the path P to each AUV by (i) identifying a first highest index jᵢ corresponding to a turning point pⱼᵢ in the path P for a first AUV when a total distance travelled by the first AUV from a first starting point Sᵢ and returning to the first starting point Sᵢ is less than or equal to a threshold distance (x), (ii) identifying a second highest index jᵢ+1 corresponding to a turning point pⱼ_{ᵢ}₊₁ in the path P for a second AUV when the total distance travelled by the second AUV from the second starting point and returning to the second starting point is less than or equal to the threshold distance, (iii) applying a boolean step function on the path obtained from the pair of lines method based on the highest indices j₁,j₂, . . . ,j_{N} identified for each AUV to evaluate whether a sum of the distances travelled by the plurality of AUVs is equal to the total distance of the path generated for the plurality of AUVs, (iv) assigning the highest indices to the corresponding AUVs if the sum of the distance travelled by the plurality of AUVs is equal to a total distance of the path generated, and (v) iteratively assigning waypoints to each AUV using: (a) an initial index j₀=1 for the first AUV, (b) computing distance constraints to determine jᵢ for each AUV I, (c) verifying whether all waypoints are covered using the function f(x). The first highest index is a second starting point. The highest index for the AUV is a point reached by the AUV before turning to a different direction. The highest index is identified by defining the function f(x) that accounts for turns in AUV trajectories. The Boolean step function f(x) determines whether the path P can be divided into N parts such that each AUV travels the threshold distance from and returning to its deployment location.

In some embodiments, the turn-aware zigzag method includes (i) performing a binary search on the boolean step function to obtain a minimal optimal threshold distance where the sum of distance between the highest indices identified for the plurality of AUVs is not equal to the total distance of the path generated for using the pair of lines method, and (ii) executing f(x*) to compute partition indices jᵢ and assigning final path segments to each AUV using the computed indices Pᵢ=[Sᵢ,pⱼ_{ᵢ₋₁},pⱼ_{ᵢ₋₁}₊₁,pⱼ_{ᵢ₋₁}₊₂, . . . ,pⱼ_{ᵢ},Sᵢ]. The method performs the binary search on f(x) to determine the minimum value of x* for which the path can be partitioned into N part. Each AUV travels from its starting point Sᵢ to the waypoints pⱼ_{ᵢ₋₁},pⱼ_{ᵢ₋₁}₊₁,pⱼ_{ᵢ₋₁}₊₂, . . . ,pⱼ_{ᵢ}, and returns to Sᵢ.

In some embodiments, the turn-aware zigzag method includes executing the boolean step function as binary search for finding the optimal threshold distance to compute optimal indices for each of the plurality of AUVs to assign respective segments to each AUV.

In some embodiments, the total distance travelled by each AUV is a sum of (i) a first distance that is a distance from a starting point to a first point in its assigned segment, (ii) a second distance that is a sum of distances between consecutive points within the assigned segment, and (iii) a third distance that is a distance from a last point in the segment back to the starting point.

In some embodiments, the Pair of Lines method includes (i) placing the first AUV at a specific coordinate (dS,0) of sensor's footprint of the first AUV aligns with an edge of the area of interest, (ii) moving the first AUV in a first direction along a vertical path, enabling the sensors to capture data from a rectangular strip of the area of interest, (iii) turning the first AUV at a boundary of the area of interest to initiate horizontal motion in a direction perpendicular to the vertical path, (iv) adjusting the sensor footprint of the first AUV during the horizontal motion by aligning a second footprint of the sensor overlaps with the nadir blind zone, (v) navigating the first AUV along a second vertical path in a reverse direction of the first vertical path to capture data from the rectangular strip that includes the nadir blind zone, and (vi) iteratively repeating the steps of turning, adjusting, and navigating along subsequent vertical and horizontal paths in a back-and-forth pattern to shift the sensor footprint for completing coverage of the area of interest, thereby minimizing data gaps and overlaps between adjacent strips to optimize coverage efficiency. The movement creates a nadir blind zone within the strip,

In some embodiments, the partition zigzag method executes a linear time O(L) traversal over the waypoints of path P to evaluate the f(x) by computing (i) a distance from the starting position Sᵢ to the first assigned waypoint pⱼ_{ᵢ₋₁}, (ii) a summation of distances between consecutive waypoints in the assigned segment, (iii) a distance from the last assigned waypoint pⱼ_{ᵢ} back to the starting position Sᵢ, and (iv) determining whether all waypoints are covered by verifying that j_{N}=L for the last AUV.

In another embodiments, a system for generating a coverage path planning (CPP) for a plurality of Autonomous underwater vehicles (AUVs) with nadir gaps. The system includes a server that includes a memory and a processor. The memory includes set of instructions. The processor executes the set of instructions and is configured to (i) receive input from a user through a user device that is communicatively connected to the central server through a network, (ii) generate a path with a nadir gap based on the area of interest, (iii) determine a path planning method from a plurality of path planning methods based on an operational priority and the starting point of the plurality of AUVs, (iv) generate the CPP for the plurality of AUVs by dividing the path into a plurality of segments by applying the determined path planning method on the path based on the starting point of the plurality of AUVs, thereby each segment is assigned to each AUV, and (v) transmit the generated CPP to the plurality of AUVs that are communicatively connected to the central server through the network. The input includes an area of interest, a count of the plurality of AUVs, a respective starting point of the plurality of AUVs, and an operational constraint. The path includes a plurality of waypoints on a two-dimensional (2D) plane using a pair of lines method,

The system for multi-AUV coverage path planning in underwater surveillance offers significant advantages, particularly in addressing the critical issue of nadir gaps areas directly beneath the AUVs that are often left uncovered. This system is the first of its kind to effectively manage these gaps, ensuring complete coverage of the target area. The system allows for strategic planning tailored to specific operational needs. The system dynamically determines a mission strategy that optimizes either the maximum distance travelled by any AUV or the total number of turns made along the path. Additionally, the system is highly adaptive, accommodating different AUV deployment locations and sensor characteristics, which makes the system versatile for various underwater missions. The system efficiently handles any number of AUVs available for deployment as input and balances workload among multiple AUVs, potentially reducing individual vehicle wear and energy consumption. By efficiently partitioning a single-AUV path into multiple segments for multi-AUV deployment, the system enhances resource utilization, ultimately lowering mission costs and time compared to traditional single-AUV operations. This comprehensive approach ensures that marine exploration and surveillance missions are conducted more effectively and economically.

### BRIEF DESCRIPTION OF THE DRAWINGS

The embodiments herein will be better understood from the following detailed description with reference to the drawings, in which:

FIG. 1 illustrates a system for generating a coverage path planning for Autonomous Underwater vehicles according to some embodiments herein;

FIG. 2 illustrates an exploded view of a central server of FIG. 1 according to some embodiments herein;

FIGS. 3A and 3B illustrate a seafloor coverage of a sidescan sonar-equipped AUV, depicting a nadir gap and the relationship to a sensor footprint during surveying, according to some embodiments;

FIG. 4 illustrates a Partition zigzag method for dividing a path into segments, each assigned to a different Autonomous Underwater Vehicle (AUV) according to some embodiments herein;

FIG. 5 illustrates an exemplary view of a ‘Partition Zigzag’ strategy executed by four Autonomous Underwater Vehicles (AUVs), each with a nadir gap, to cover an area of interest R according to some embodiments herein;

FIG. 6 illustrates an exemplary view of a ‘Turn-Aware Zigzag’ method executed by four Autonomous Underwater Vehicles (AUVs), each with a nadir gap, to cover an area of interest R according to some embodiments herein;

FIG. 7 illustrates a ‘Pair of Lines’ method of FIG. 1 according to some embodiments herein;

FIG. 8 illustrates a method for generating a coverage path planning for Autonomous Underwater vehicles according to some embodiments herein; and

FIG. 9 is a schematic diagram of a computer architecture in accordance with the embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted to not unnecessarily obscure the embodiments herein. The examples used herein are intended merely to facilitate an understanding of ways in which the embodiments herein may be practiced and to further enable those of skill in the art to practice the embodiments herein.

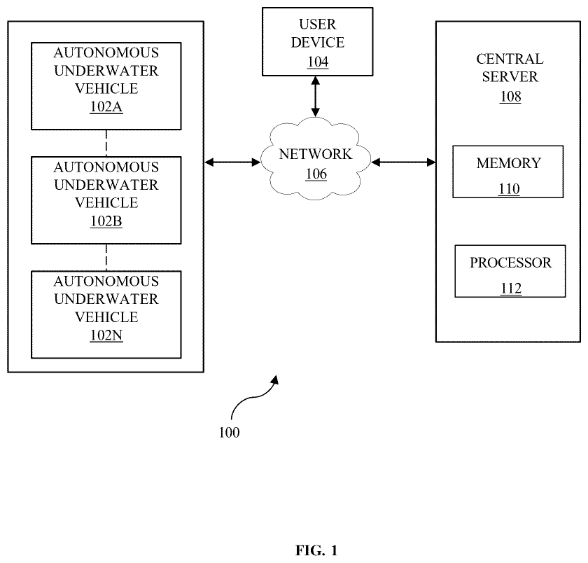

As mentioned, there remains a need to address the aforementioned technical drawbacks for a system to enable effective generation of coverage path planning (CPP) in underwater surveillance missions, accounting for nadir gaps. The system for generating a CPP for Autonomous Underwater Vehicles (AUVs) in underwater surveillance with nadir gap management, according to some embodiments herein, is designed to facilitate efficient and comprehensive underwater exploration and surveillance using multiple autonomous underwater vehicles (AUVs). The system leverages advanced path planning methods to manage nadir gaps (blind spots in sonar coverage) and optimizes the deployment of AUVs for complete area coverage while minimizing mission time and resource utilization. Referring now to the drawings, and more particularly to FIGS. 1 through 7, where similar reference characters denote corresponding features consistently throughout the figures, there are shown preferred embodiments.

FIG. 1 illustrates a system for generating a Coverage Path Planning for Autonomous Underwater Vehicles according to some embodiments herein. The system 100 includes Autonomous Underwater Vehicles (AUVs) 102A-N, a central server 108, a user device 104 and a network 106. Each AUV is equipped with a streamlined, hydrodynamic structure designed for stable operation underwater. The main body houses the core components necessary for autonomous navigation and mission execution. The AUVs 102A-N are equipped with propulsion mechanisms such as thrusters or propellers to facilitate movement at a constant speed and maintain altitude during the mission. The AUVs 102A-N are outfitted with control systems that integrates navigation, guidance, and stabilization functions. The system 100 ensures that the AUV can follow pre-defined paths, execute turns, and return to its deployment location autonomously. The AUVs 102A-N include sensor units. The sensor unit may be an Interferometric Side-Scan Sonar sensor used for underwater surveillance. The sensor units provide high-resolution imaging of the seabed. The sensor unit leaves a nadir gap (blind zone) directly beneath the AUV, which the system 100 compensates using coverage path planning methods. The AUVs 102A-N are equipped with onboard processing units that handle real-time data processing, navigation, and communication tasks. The onboard processing units executes preloaded algorithms, enabling the AUVs 102A-N to follow planned paths and adjust its trajectory based on mission objectives. The AUVs 102A-N are equipped with communication units to facilitate communication with other AUVs 102A-N and the central control station. The communication units may include acoustic modems. The communication units enable the exchange of mission data and ensure coordination between multiple AUVs 102A-N. Each AUV has a rechargeable battery that provides sufficient power for extended underwater missions. The system 100 is designed to optimize power consumption to maximize mission duration.

The central server 108 includes a memory 110 and a processor 112. The memory 110 includes a set of instructions. The processor 112 executes the set of instructions. The central server 108 is configured to design the coverage paths for all deployed AUVs 102A-N using the path planning methods. The path planning methods includes a partition zigzag and a turn-aware zigzag method. The central server 108 generates a set of optimal paths for each AUV, accounting for nadir gaps, vehicle speed, and operational constraints. Once the AUVs 102A-N are deployed, they autonomously follow the pre-defined paths, ensuring complete coverage of the area of interest.

The user device 104, without limitation, may include a mobile phone, a kindle, a PDA (Personal Digital Assistant), a tablet, a music player, a computer, an electronic notebook, or a smartphone. The user device 104 may include a graphical user interface (GUI) that allows users to provide inputs for generating the CPP. The inputs include defining an area of interest, a count of the AUVs, a respective starting point of the AUVs, an operational constrain and monitor the mission's progress. The operational constraint includes minimizing a maximum distance travelled by at least one of the AUVs 102A-N or minimizing a total number of turns executed by any one of the AUVs 102A-N. The interface provides real-time visualization of AUV locations and path coverage. The user device 104 is communicatively connected to the central server 108 through the network 106. The user device 104 communicates the inputs from the user device 104 to the central server 108 through the network 106. The central server 108 is configured to generate the CPP for the plurality of AUVs 102A-N based on the inputs received from the user device 104. The generated CPP is transmitted to the AUVs 102A-N that are communicatively connected to the central server 108 through the network 106. The network 106 facilitates data exchange between the central server 108 and the deployed AUVs 102A-N. The central server 108 may use satellite, radio, or acoustic communication channels depending on the environment. The network 106 enables real-time coordination between AUVs 102A-N and the control station, ensuring that the mission objectives are met effectively.

In some embodiments, the network 106 is a wireless network or a wireless network. In some embodiments, the network 106 is a combination of a wired network and a wireless network. In some embodiments, the network 106 is an Internet. In some embodiments, the network 106 is a Bluetooth Low Energy (BLE).

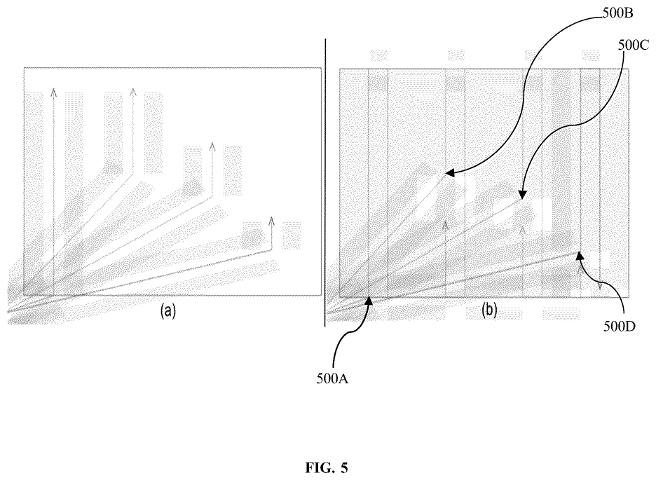

The central server 108 includes a partition zigzag module configured to minimize the maximum distance travelled by any of the AUVs 102A-N. The partition zigzag module 208 takes as input the path P=[p₁, p₂, . . . , P_{L}] generated by the ‘Pair of Lines’ method for a single AUV (Explained in FIG. 5), which consists of L waypoints on a two-dimensional (2D) plane, where each waypoint pᵢ is a point on the two-dimensional 2D plane.

The partition zigzag module is configured to partition this path into approximately equal parts, ensuring that each part is covered independently by a different AUV while minimizing the maximum distance any AUV has to travel. As the line-segments joining the waypoints in P do not intersect with themselves, no explicit coordination between AUVs 102A-N is required. However, naively dividing the path equally (that is, L/N) leads to an unfair division of work for the AUVs 102A-N, where N is the number of AUVs available for planning.

To facilitate efficient computation of maximum path length to be travelled by any AUV, a Boolean step function f(x) is introduced which evaluates to True if P is divided into N parts such that each AUV travels a distance of at most x, and False otherwise. The goal is to find the minimum x (x*) for which f(x) is True.

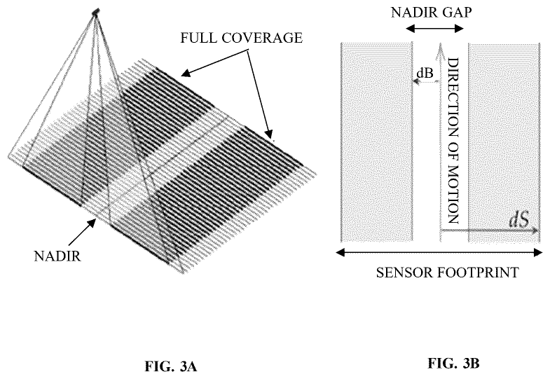

Given a value of x, the partition zigzag module checks if it's possible to totally cover R (Explained in FIG. 3A-B) by letting each AUV travel a distance of at most x, where R is the rectangular area of interest in the global frame that needs to be covered once. For the first AUV 102A, the highest index jᵢ≤L is found such that the distance incurred travelling from p₁ to pⱼ_{₁} while starting from and returning to Sᵢ is ≤x, where S is the list of AUV deployment locations that is the starting and returning point for the i^{th} AUV 102N and S₁ is the starting point of the first AUV 102A. The distance between two points p, q is denoted as d(p, q). To compute the distance between the two points, iteration is performed over P starting from p₁ and at each waypoint pₖ to calculate the distance from S₁ to p₁, p₁ to pₖ through p_{z} (1≤z<k) and the distance from pₖ to S₁. Thus, after finding the highest index j₁ for the first AUV 102A, the same process is repeated for the second AUV 102B starting from j₁, finding the highest index j₂ such that the second AUV 102B travels≤x distance. In general, for a AUV i 102N with starting coordinate Sᵢ, the highest index jᵢ≤L is determined such that, starting from and returning to Sᵢ, the AUV i covers P[pⱼ_{ᵢ₋₁}:pⱼ_{ᵢ}] portion of the path P (assuming indexing with j₀=1) while incurring a distance of ≤x. Thus, for AUV i 102N, at waypoint pₖ, the following is computed.

$$d ( {S}_{i} , {p}_{{j}_{i - 1}} ) + {\sum }_{z = {j}_{i} - 1}^{k - 1} d ( {p}_{z} , {p}_{z + 1} ) + d ( {p}_{k} , {S}_{i} )$$

The first and last term in the above summation are constant time operations while P[pⱼ_{ᵢ₋₁}:pₖ] (the middle summation) can be computed efficiently by maintaining a running sum. In the end, if j_{N} is L (that is, the last AVU 102N can reach the end of path P within the allowed distance threshold x), then f(x) returns True (and False otherwise).

The partition zigzag module executes a linear time O(L) traversal over the waypoints of path P to evaluate the f(x) by computing (i) a distance from the starting position Si to the first assigned waypoint pⱼ_{ᵢ₋₁}, (ii) a summation of distances between consecutive waypoints in the assigned segment, (iii) a distance from the last assigned waypoint pⱼ_{ᵢ} back to the starting position Si, and (iv) determining whether all waypoints are covered by verifying that j_{N}=L for the last AUV 102N.

The partition zigzag module includes executing the boolean step function as binary search for finding the optimal threshold distance to compute optimal indices for each of the AUVs 102A-N to assign respective segments to each AUV.

Finally, to obtain x*, a binary search on f(x) is used to find the minimal x to which f(x) evaluates to True. After determining the optimal value x*, f(x*) is again run to compute the index jᵢ for the i^{th} AUV and assign their respective paths to them. Formally, the path of AUV i 102N is

$${P}_{i} = [ {S}_{i} , {p}_{{j}_{i - 1}} , {p}_{{j}_{i - {1}^{+ 1}}} , {p}_{{j}_{i - {1}^{+ 2}}} , … , {p}_{{j}_{i}} , {S}_{i} ]$$

The partition zigzag module helps to attain complete coverage of the area of interest R while minimizing the maximum distance travelled by any AUV consequently, minimizing the overall completion time as the speed of an AUV is fixed.

Algorithmic steps of the Partition Zigzag Module:

Step 1: Generate a path P using ‘Pair of Lines’ method (defined for single AUV). Let L be the length of the path P.

Step 2: Define function f(x) to check if path P can be divided into N parts such that each AUV travels at maximum a distance of x units starting from and returning to their respective deployment locations.

Step 2a: Initialize j₀=1 (starting index for the first AUV 102A)

Step 2b: For each AUV i from 1 to N:

Step 2c: Initialize current_distance for this AUV to be 0

Step 2d: Initialize k=jᵢ₋₁ (start from where previous AUV ended)

Step 2e: While k<L and current_distance≤x:

Step 2f: Add distance (Sᵢ,pₖ) to current_distance if k=jᵢ₋₁

Step 2g: Add distance (pₖ₋₁, pₖ) to current_distance if k>jᵢ₋₁

Step 2h: If current_distance+distance (pₖ, Sᵢ)≤x, update jᵢ=k and increment k

Step 2i: If i=N and jᵢ<L, return False (couldn't cover all waypoints)

Step 2j: If above While loop completes without returning False, return True

Step 3: Perform binary search on f(x) to find minimum x* where f(x*) is True.

Step 4: Run f(x*) to compute partition indices j; for each AUV i.

Step 5: Assign path segment Pᵢ=[Sᵢ,pⱼ_{ᵢ₋₁},pⱼ_{ᵢ₋₁}₊₁,pⱼ_{ᵢ₋₁}₊₂, . . . ,pⱼ_{ᵢ},Sᵢ] to AUV i.

Step 6: Output final partitioned paths for all N AUVs 102A-N.

The central server 108 includes a Turn-Aware Zigzag module configured to minimizes the total number of turns made by the AUVs 102A-N. Turn-Aware Zigzag module takes as input the path P=[p1, p2, . . . , pL] generated by the ‘Pair of Lines’ method for a single AUV (Explained in FIG. 5), which consists of L waypoints on a 2D plane, where each waypoint pᵢ is a point on the 2D plane. The Turn-Aware Zigzag module defines the function f(x) to account for turns in the AUVs' trajectories. For the i^{th} AUV 102N, the Turn-Aware Zigzag module identifies the highest index jᵢ, where pⱼ_{ᵢ} is a turning point (a waypoint where a turn occurs) in the path P. The distance travelled up to that turning point, including the trip from and back to Sᵢ (the starting point) is constrained to be at most x. Each AUV concludes its trajectory at a turning point to avoid unnecessary additional turns. As a result, the initial point for the next AUV, i+1, is set to pⱼ_{ᵢ}₊₁ instead of pⱼ_{ᵢ}, since the segment pⱼ_{ᵢ}→pⱼ_{ᵢ}₊₁, involves a turn that is no longer required. The next AUV must reach Pⱼ_{ᵢ}₊₁ from its start Sᵢ₊₁ before beginning its assigned path. The turn-aware zigzag module includes executing the boolean step function as binary search for finding the optimal threshold distance to compute optimal indices for each of the AUVs 102A-N to assign respective segments to each AUV. To ensure complete coverage without exceeding the number of turns made by the “Pair of Lines” strategy (for a single AUV), the turn aware zigzag module performs a binary search on f(x) to determine the maximal distance x* that any AUV must travel. This guarantees that the total number of turns does not increase, optimizing the system 100 for turn-aware navigation.

Algorithmic steps of the Turn-Aware Zigzag module:

Step 1: Generate a path P using ‘Pair of Lines’ method (defined for single AUV). Let L be the length of the path P.

Step 2: Define function f(x) to check if path P can be divided into N parts such that each AUV travels at maximum a distance of x units starting from and returning to their respective deployment locations.

Step 2a: Initialize j₀=1 (starting index for the first AUV 102A)

Step 2b: For each AUV i from 1 to N:

Step 2c: Initialize current_distance for this AUV to be 0

Step 2d: Initialize k=jᵢ₋₁ (start from where previous AUV ended)

Step 2e: While k<L and current_distance≤x:

Step 2f: Add distance (Sᵢ, pₖ) to current_distance if k=jᵢ₋₁

Step 2g: Add distance (pₖ₋₁, pₖ) to current_distance if k>jᵢ₋₁

Step 2h: If current_distance+distance (pₖ, Sᵢ)≤x and pⱼ is a turning point, update j; =k and increment k

Step 2i: If no turning point was found within distance x, return False

Step 2j: Set starting point for next AUV: jᵢ₋₁=jᵢ+1

Step 2k: If i=N and jᵢ<L, return False (couldn't cover all waypoints)

Step 21: If above While loop completes without returning False, return True

Step 3: Perform binary search on f(x) to find minimum x* where f(x*) is True.

Step 5: Assign path segment Pᵢ=[Sᵢ,pⱼ_{ᵢ₋₁},pⱼ_{ᵢ₋₁}₊₁,pⱼ_{ᵢ₋₁}₊₂, . . . ,pⱼ_{ᵢ},Sᵢ] to AUV i 102N.

Step 6: Output final partitioned paths for all N AUVs 102A-N.

The central server 108 dynamically executes either the Partition Zigzag method or Turn-Aware Zigzag method based on the operational priority. If minimizing the overall mission completion is the main objective, the central server 108 selects the Partition zigzag method, which focuses on minimizing the maximum distance travelled by any AUV. This ensures efficient path allocation to reduce time. On the other hand, if the priority is to reduce the total number of turns made by the AUVs 102A-N the central server 108 employs the Turn-Aware Zigzag method, which optimizes the paths to minimize turns, enhancing navigational efficiency. Both strategies are flexible and can handle multiple AUVs 102A-N adapting to the specific mission requirements to achieve optimal performance.

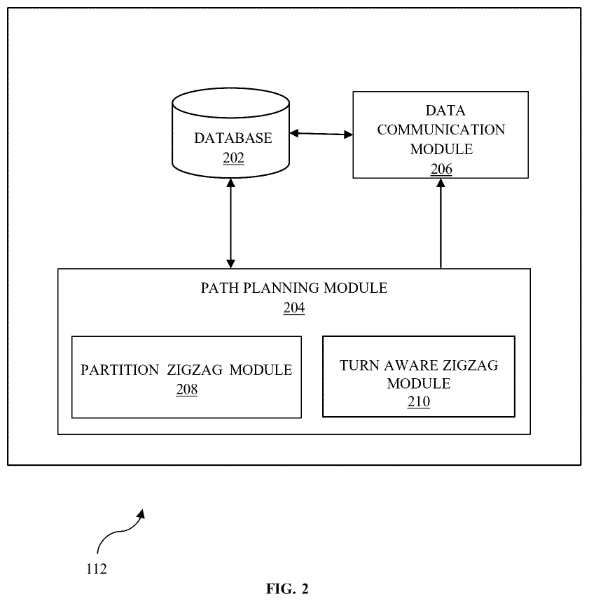

FIG. 2 illustrates an exploded view of a central server 108 of FIG. 1 according to some embodiments herein. The central server 108 includes a database 202, a path planning module 204, including the Partition Zigzag module 208 and the Turn-Aware Zigzag module 210, and a communication module 206.

The path planning module 204 is responsible for orchestrating the overall path planning and coordination of multiple AUVs (Autonomous Underwater Vehicles) 102A-N to ensure efficient coverage of the designated area of interest R. The path planning module 204 integrates both the Partition Zigzag module 208 and the Turn-Aware Zigzag module 210, providing flexible strategies based on the mission's specific requirements. The path planning module 204 ensures that all AUVs 102A-N are assigned appropriate coverage paths while considering factors such as distance travelled and the number of turns required. The Partition Zigzag module 208 is designed to minimize the maximum distance travelled by any AUV. The Partition Zigzag module 208 achieves this by dividing the area of interest into sections in such a way that the overall mission completion time is reduced, since AUVs 102A-N operate at a fixed speed. This strategy ensures efficient coverage, with each AUV assigned a balanced portion of the area to minimize the longest individual travel path, thus optimizing for faster mission completion. The Turn-Aware Zigzag module 210, on the other hand, focuses on minimizing the total number of turns made by the AUVs 102A-N. The Turn-Aware Zigzag module 210 partitions the coverage path in a manner that reduces unnecessary maneuvers, particularly at turning points, which can be inefficient. By ending AUV trajectories at turning points and avoiding redundant turns, the Turn-Aware Zigzag module 210 optimizes the routes of AUVs 102A-N to achieve complete coverage with fewer directional changes, improving overall navigational efficiency. The data communication module 206 is responsible for facilitating the seamless exchange of instructions and information between the central server 108 and the onboard processing units 108A-N of the AUVs 102A-N. The data communication module 206 ensures real-time and reliable communication by transmitting mission-specific data, such as coverage paths, waypoints, and operational parameters, from the path planning module 204 to the AUVs 102A-N.

FIGS. 3A and 3B illustrate a seafloor coverage of a sidescan sonar-equipped AUV, depicting a nadir gap and the relationship to a sensor footprint during surveying, according to some embodiments. FIG. 3A depicts an elevated perspective of the seafloor coverage through sidescan sonar, highlighting a distortion in coverage near the centre (nadir). The exploration of the seafloor using AUVs 102A-N with nadir gaps in two-dimensional (2D) environment is executed using the following tuple <R, N, S, v, dS, dB>. Here R denotes the rectangular area of interest of size L×B in the global frame whole of which needs to be covered once. The R is transformed such that its bottom-left corner is at (0, 0) coordinate on a 2D plane. N is the number of AUVs available for planning. S is the list of AUV deployment locations where Sᵢ is the starting and returning point for the i^{th} AUV. v is the (constant) speed at which each AUV travels, once deployed. FIG. 3B shows the nadir gap as a subsection of sensor footprint in modelling of an AUV's survey sensor. Here, dS is the length of sensor footprint covered by the AUV perpendicular to its direction of motion. The system 100 models the length of sensor footprint as a scalar quantity on both sides of the motion. dB denotes the distance of blind zone left by the AUV perpendicular to its direction of motion.

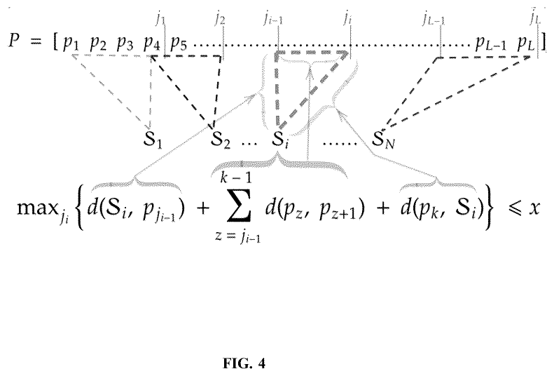

FIG. 4 illustrates a Partition zigzag method for dividing a path into segments, each assigned to a different Autonomous Underwater Vehicle (AUV) according to some embodiments herein. FIG. 4 visually explains how the Partition zigzag method divides the path into segments, with each AUV responsible for covering a specific portion of the path. The total distance for each segment is calculated efficiently and that the segments are assigned in a way that minimizes the maximum distance any AUV has to travel. This balance in workload helps optimize the mission by reducing the overall completion time and energy consumption for the AUV. Path P: The top part of the figure shows the path P=[p₁, p₂, . . . , p_{L}] which consists of waypoints that the AUVs 102A-N need to visit. The path is a sequence of points on a 2D plane, and the goal is to divide this path among the AUVs 102A-N. Segments and Starting Points: The path P is divided into segments, each assigned to a different AUV. The figure shows different segments, such as [p₁, p₂, p₃, p₄], assigned to the first AUV 102A, [p₅, . . . ] assigned to the second AUV 102B, and so on. S₁, S₂, . . . , S_{N} represent the starting points of the AUVs. Each AUV starts from its respective starting point, covers its assigned segment of the path, and returns to the same starting point. Division of the Path: The path is divided at specific indices j₁, j₂, . . . , j_{N}.

These indices represent the waypoints where the path is divided among the AUV. For example, the first AUV 102A covers the path segment from p₁ to pⱼ, the second AUV 102B covers from pⱼ₁ to pⱼ₂ and so on. Distance Calculation: The lower part of the figure shows the mathematical expression used to calculate the total distance travelled by each AUV. For a given AUV i, the total distance is calculated as the sum of three components:

d(Sᵢ,pⱼ_{ᵢ₋₁}): The distance from the starting point Sᵢ to the first waypoint in its assigned segment.

$${\sum }_{z = {j}_{i} - 1}^{k - 1} d ( {p}_{z} , {p}_{z + 1} ) :$$

The sum of distances between consecutive waypoints within the assigned segment.

d(pₖ,Sᵢ): The distance from the last waypoint in the segment back to the starting point Sᵢ.

The total distance travelled by each AUV is a sum of (i) a first distance that is a distance from a starting point to a first point in its assigned segment, (ii) a second distance that is a sum of distances between consecutive points within the assigned segment, and (iii) a third distance that is a distance from a last point in the segment back to the starting point.

The objective is to minimize the maximum distance travelled by any AUV, ensuring that the total distance for each AUV does not exceed the threshold x.

FIG. 5 illustrates a ‘Partition Zigzag’ method executed by four Autonomous Underwater Vehicles (AUVs) 102A-N, each with a nadir gap, to cover an area of interest R according to some embodiments herein. In this method, the AUVs 102A-N are distributed unevenly at the starting points or locations 500A-N, as shown in figure (a) and figure (b), with each AUV positioned at different points along the boundary of the area R. Each AUV follows a zigzag path, with the paths assigned in a way that ensures an equal division of the workload, even if the paths themselves are of uneven lengths. This method ensures that despite the different starting points and varying path lengths, each AUV covers its assigned section of the area efficiently.

As depicted in figure (b), the uneven division of the paths is balanced so that all AUVs 102A-N travel approximately the same distance. This leads to all AUVs 102A-N completing their respective trajectories at nearly the same time, ensuring synchronized coverage of the area of interest. This coordinated strategy allows for efficient use of resources, minimizing the time needed to scan the entire region while ensuring no gaps are left uncovered, even in the nadir zones beneath each AUV.

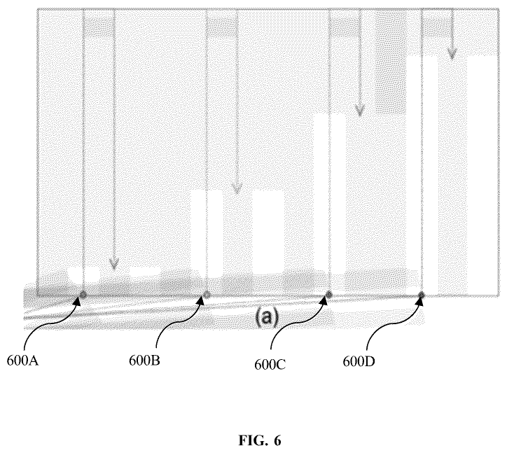

FIG. 6 illustrates an exemplary view of a ‘Turn-Aware Zigzag’ method executed by four Autonomous Underwater Vehicles (AUVs) 102A-N, each with a nadir gap, to cover an area of interest R according to some embodiments herein. In this method, the AUVs 102A-N are distributed unevenly at the starting locations 600A-N with each AUV positioned at different points along the boundary of the area of interest R. The starting locations 600A-N of each AUV is a waypoint where a turn occurs. Each AUV follows the paths assigned in a way that ensures an equal division of the workload, even if the paths themselves are of uneven lengths. This method ensures that despite the different starting points 600A-N and varying path lengths, each AUV covers its assigned section of the area efficiently. Each AUV needs to travel the assigned path to ensure complete coverage of the area of interest R without increasing the total number of turns compared to number of turns made by the ‘Pair of Lines’ strategy for single AUV. This coordinated strategy allows for efficient use of resources, minimizing the time needed to scan the entire region while ensuring no gaps are left uncovered, even in the nadir zones beneath each AUV.

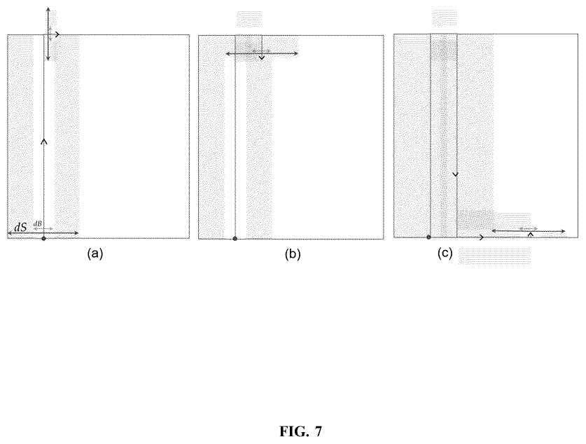

FIG. 7 illustrates a ‘Pair of Lines’ method of FIG. 1 according to some embodiments herein. Figure (a) illustrates initial positioning. The AUV starts at a specific coordinate or point (dS,0), where the left edge of its sensor footprint aligns with the left boundary of the area R. The AUV then moves vertically upwards, covering a strip of the area as the AUV ascends. This upward motion is designed to cover one side of the area with its sensor. Figure (b) illustrates horizontal shift. After reaching the top of the area R, the AUV shifts horizontally to the right. This shift positions the AUV so that its right footprint aligns with the location where the left footprint's blind spot was during the previous upward pass. Figure (c) illustrates return path. The AUV then descends vertically, covering another strip of the area, now filling in the gaps left during the initial upward motion. This descending path overlaps with the previously uncovered areas, ensuring no part of the area is left unchecked. By repeating this back-and-forth motion (moving vertically up, shifting horizontally, and then moving vertically down), the AUV can comprehensively scan the entire area R, effectively covering any gaps that may have been left during the initial pass. This strategy ensures that even the nadir gap, which is the area directly beneath the AUV, is thoroughly covered by the time the entire area is scanned. The path planning algorithm from the literatures “Per Espen Hagen. Gap filler sensors for sas. In OCEANS' 11 MTS/IEEE KONA, pages 1-6. IEEE, 2011—‘Pair of Lines’” and “Per Espen Hagen and Roy Edgar Hansen. Area coverage rate of synthetic aperture sonars. In OCEANS 2007-Europe, pages 1-5. IEEE, 2007—Maximum Area Coverage'” is used for coverage path planning with a single AUV with nadir gap.

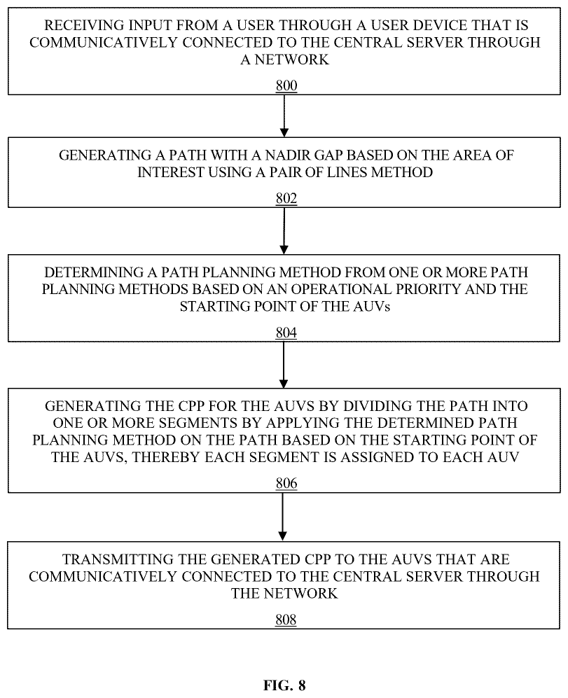

FIG. 8 illustrates a method for generating a coverage path planning for Autonomous Underwater vehicles (AUVs) 102A-N according to some embodiments herein. At a step 800, the method includes receiving input from a user through a user device 104 that is communicatively connected to the central server 108 through a network 106. At a step 802, the method includes generating a path with a nadir gap based on the area of interest using a pair of lines method. At a step 804, the method includes determining a path planning method from one or more path planning methods based on an operational priority and the starting point of the AUVs. At a step 806, the method includes generating the CPP for the AUVs 102A-N by dividing the path into one or more segments by applying the determined path planning method on the path based on the starting point of the AUVs, thereby each segment is assigned to each AUV. At a step 808, the method includes transmitting the generated CPP to the AUVs 102A-N that are communicatively connected to the central server through the network 106.

In some embodiments, the operational constraint includes minimizing a maximum distance travelled by at least one of the AUVs 102A-N or minimizing a total number of turns executed by any one of the AUVs 102A-N.

In some embodiments, the one or more path planning methods includes a partition zigzag method and a turn-aware zigzag method.

In some embodiments, the partition zigzag method iteratively assigns the segments of the path P to each AUV by (i) identifying a first highest index j₁≤L for a first AUV 102A when a total distance travelled by the first AUV 102A from a first starting point S₁ to first waypoint P₁, traversing intermediate waypoints, and returning to the first starting point S₁ is less than or equal to a threshold distance (x) S₁ is ≤x, (ii) identifying a second highest index for a second AUV 102B when a total distance travelled by the second AUV 102B from the second starting point and returning to the second starting point is less than or equal to the threshold distance, (iii) repeating the process for each subsequent AUV, determining the highest index jᵢ for each AUV i starting from j₍ᵢ₋ₙ₎, such that the AUV travels at most distance or the threshold distance x before returning to its starting position Sᵢ, (iv) maintaining a running sum of distances at each waypoint to enable efficient computation of partitioning indices, (v) applying a boolean step function on the path obtained from the pair of lines method based on the highest indices j₁,j₂, . . . j_{N} identified for each AUV to evaluate whether a sum of the distances travelled by the plurality of AUVs, is equal to the total distance of the path generated for the AUVs 102A-N, (vi) assigning the highest indices to the corresponding AUVs 102A-N if the sum of the distance travelled by the AUVs 102A-N is equal to the total distance of the path, and (vii) iteratively assigning waypoints to each AUV using: (a) an initial index j₀=1 for the first AUV 102A, (b) computing distance constraints to determine jᵢ for each AUV i, (c) verifying whether all waypoints are covered using the function f(x). The Boolean step function f(x) determines whether the path P can be divided into N parts such that each AUV travels the threshold distance from and returning to its deployment location. The first highest index is a second starting point. The highest index for the AUV is the furthest point in its path that the AUV reaches before returning to its starting point,

In some embodiments, the partition zigzag method includes (i) performing a binary search on the boolean step function f(x) to obtain an optimal threshold distance if the sum of the highest indices identified for the AUVs 102A-N is not equal to the total distance of the path generated using the pair of lines method, (ii) executing f(x*) to compute partition indices jᵢ and assigning final path segments to each AUV using the computed indices Pᵢ=[Sᵢ,pⱼ_{ᵢ₋₁},pⱼ_{ᵢ₋₁}₊₁,pⱼ_{ᵢ₋₁}₊₂, . . . ,pⱼ_{ᵢ},Sᵢ]. The method performs the binary search on the f(x) to determine the minimum value of x* for which the path can be partitioned into N part. Each AUV travels from its starting point Sᵢ to the waypoints Pⱼ_{ᵢ₋₁},pⱼ_{ᵢ₋₁}₊₁,pⱼ_{ᵢ₋₁}₊₂, . . . ,pⱼ_{ᵢ}, and returns to Sᵢ.

In some embodiments, the partition zigzag method includes executing the boolean step function as binary search for finding the optimal threshold distance to compute optimal indices for each of the AUVs 102A-N to assign respective segments to each AUV.

In some embodiments, the turn-aware zigzag method iteratively assigns the segments of the path P to each AUV by (i) identifying a first highest index jᵢ corresponding to a turning point pⱼᵢ in the path P for a first AUV 102A when a total distance travelled by the first AUV 102A from a first starting point Sᵢ and returning to the first starting point Sᵢ is less than or equal to a threshold distance (x), (ii) identifying a second highest index jᵢ+1 corresponding to a turning point pⱼ_{ᵢ}₊₁ in the path P for a second AUV 102B when the total distance travelled by the second AUV 102B from the second starting point and returning to the second starting point is less than or equal to the threshold distance, (iii) applying a boolean step function on the path obtained from the pair of lines method based on the highest indices j₁,j₂, . . . ,j_{N} identified for each AUV to evaluate whether a sum of the distances travelled by the plurality of AUVs is equal to the total distance of the path generated for the AUVs 102A-N, (iv) assigning the highest indices to the corresponding AUVs if the sum of the distance travelled by the AUVs 102A-N is equal to a total distance of the path generated, and (v) iteratively assigning waypoints to each AUV using: (a) an initial index j₀=1 for the first AUV 102A, (b) computing distance constraints to determine jᵢ for each AUV i, (c) verifying whether all waypoints are covered using the function f(x). The first highest index is a second starting point. The highest index for the AUV is a point reached by the AUV before turning to a different direction. The highest index is identified by defining the function f(x) that accounts for turns in AUV trajectories. The Boolean step function f(x) determines whether the path P can be divided into N parts such that each AUV travels the threshold distance from and returning to its deployment location.

In some embodiments, the turn-aware zigzag method includes (i) performing a binary search on the boolean step function to obtain a minimal optimal threshold distance where the sum of distance between the highest indices identified for the AUVs 102A-N is not equal to the total distance of the path generated for using the pair of lines method, and (ii) executing f(x*) to compute partition indices jᵢ and assigning final path segments to each AUV using the computed indices Pᵢ=[Sᵢ,pⱼ_{ᵢ₋₁},pⱼ_{ᵢ₋₁}₊₁,pⱼ_{ᵢ₋₁}₊₂, . . . ,pⱼ_{ᵢ},Sᵢ]. The method performs the binary search on f(x) to determine the minimum value of x* for which the path can be partitioned into N part. Each AUV travels from its starting point Sᵢ to the waypoints pⱼ_{ᵢ₋₁},pⱼ_{ᵢ₋₁}₊₁,pⱼ_{ᵢ₋₁}₊₂, . . . ,pⱼ_{ᵢ}, and returns to Sᵢ.

In some embodiments, the turn-aware zigzag method includes executing the boolean step function as binary search for finding the optimal threshold distance to compute optimal indices for each of the AUVs 102A-N to assign respective segments to each AUV.

In some embodiments, the total distance travelled by each AUV is a sum of (i) a first distance that is a distance from a starting point to a first point in its assigned segment, (ii) a second distance that is a sum of distances between consecutive points within the assigned segment, and (iii) a third distance that is a distance from a last point in the segment back to the starting point.

In some embodiments, the Pair of Lines method includes (i) placing the first AUV 102A at a specific coordinate (dS,0) of sensor's footprint of the first AUV 102A aligns with an edge of the area of interest, (ii) moving the first AUV 102A in a first direction along a vertical path, enabling the sensors to capture data from a rectangular strip of the area of interest, (iii) turning the first AUV 102A at a boundary of the area of interest to initiate horizontal motion in a direction perpendicular to the vertical path, (iv) adjusting the sensor footprint of the first AUV 102A during the horizontal motion by aligning a second footprint of the sensor overlaps with the nadir blind zone, (v) navigating the first AUV 102A along a second vertical path in a reverse direction of the first vertical path to capture data from the rectangular strip that includes the nadir blind zone, and (vi) iteratively repeating the steps of turning, adjusting, and navigating along subsequent vertical and horizontal paths in a back-and-forth pattern to shift the sensor footprint for completing coverage of the area of interest, thereby minimizing data gaps and overlaps between adjacent strips to optimize coverage efficiency. The movement creates a nadir blind zone within the strip,

In some embodiments, the partition zigzag method executes a linear time O(L) traversal over the waypoints of path P to evaluate the f(x) by computing (i) a distance from the starting position Sᵢ to the first assigned waypoint pⱼ_{ᵢ₋₁}, (ii) a summation of distances between consecutive waypoints in the assigned segment, (iii) a distance from the last assigned waypoint pⱼ_{ᵢ} back to the starting position Sᵢ, and (iv) determining whether all waypoints are covered by verifying that j_{N}=L for the last AUV.

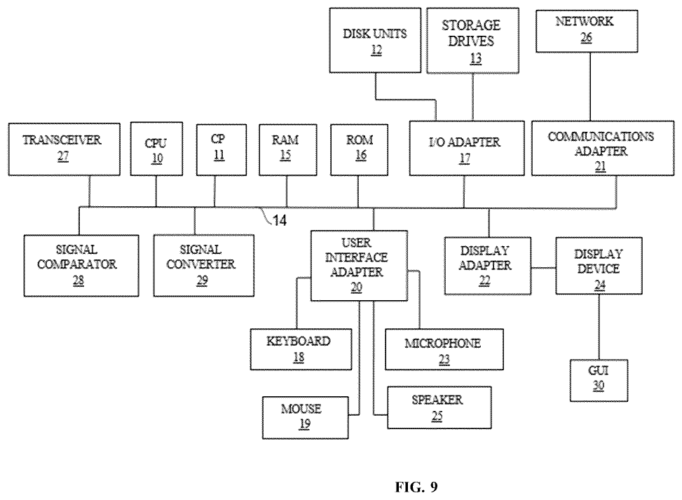

A representative hardware environment for practicing the embodiments herein is depicted in FIG. 9 with reference to FIGS. 1 through 8. This schematic drawing illustrates a hardware configuration of a central server 108/computer system in accordance with the embodiments herein. The central server 108/computer includes at least one processing device 10 and a cryptographic processor 11. The special-purpose CPU 10 and the cryptographic processor (CP) 11 may be interconnected via system bus 14 to various devices such as a random access memory (RAM) 15, read-only memory (ROM) 16, and an input/output (I/O) adapter 17. The I/O adapter 17 can connect to peripheral devices, such as disk units 12 and tape drives 13, or other program storage devices that are readable by the system. The central server 108/computer can read the inventive instructions on the program storage devices and follow these instructions to execute the methodology of the embodiments herein. The central server 108/computer system further includes a user interface adapter 20 that connects a keyboard 18, mouse 19, speaker 25, microphone 23, and/or other user interface devices such as a touch screen device (not shown) to the bus 14 to gather user input. Additionally, a communication adapter 21 connects the bus 14 to a data processing network 26, and a display adapter 22 connects the bus 14 to a display device 24, which provides a graphical user interface (GUI) 30 of the output data in accordance with the embodiments herein, or which may be embodied as an output device such as a monitor, printer, or transmitter, for example. Further, a transceiver 27, a signal comparator 28, and a signal converter 29 may be connected with the bus 14 for processing, transmission, receipt, comparison, and conversion of electric or electronic signals.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope.

What is claimed is:

1. A processor-implemented method for generating a coverage path planning (CPP) for a plurality of Autonomous underwater vehicles (AUVs) with nadir gaps, wherein the method comprises:
receiving input from a user through a user device that is communicatively connected to the central server through a network, wherein the input comprises an area of interest, a count of the plurality of AUVs, a respective starting point of the plurality of AUVs, and an operational constraint;
generating, using a pair of lines method, a path with a nadir gap based on the area of interest, wherein the path comprises a plurality of waypoints on a two-dimensional (2D) plane;
determining a path planning method from a plurality of path planning methods based on an operational priority and the starting point of the plurality of AUVs;
generating the CPP for the plurality of AUVs by dividing the path into a plurality of segments by applying the determined path planning method on the path based on the starting point of the plurality of AUVs, thereby each segment is assigned to each AUV; and
transmitting the generated CPP to the plurality of AUVs that are communicatively connected to the central server through the network.

2. The processor-implemented method of claim 1, wherein the operational constraint comprises minimizing a maximum distance travelled by at least one of the plurality of AUVs or minimizing a total number of turns executed by any one of the plurality of AUVs.

3. The processor-implemented method of claim 1, wherein the plurality of path planning methods comprises a partition zigzag method and a turn-aware zigzag method.

4. The processor-implemented method of claim 3, wherein the partition zigzag method iteratively assigns the segments of the path P to each AUV by,
(i) identifying a first highest index j₁≤L for a first AUV when a total distance travelled by the first AUV from a first starting point S₁ to first waypoint P₁, traversing intermediate waypoints, and returning to the first starting point S₁ is less than or equal to a threshold distance (x) S₁ is ≤x, wherein the first highest index is a second starting point, wherein the highest index for the AUV is the furthest point in its path that the AUV reaches before returning to its starting point;
(ii) identifying a second highest index for a second AUV when a total distance travelled by the second AUV from the second starting point and returning to the second starting point is less than or equal to the threshold distance;
(iii) repeating the process for each subsequent AUV, determining the highest index jᵢ for each AUV i starting from jᵢ₋₁, such that the AUV travels at most distance or the threshold distance x before returning to its starting position Sᵢ;
(iv) maintaining a running sum of distances at each waypoint to enable efficient computation of partitioning indices;
(v) applying a boolean step function on the path obtained from the pair of lines method, to evaluate whether a sum of the distances travelled by the plurality of AUVs, based on the highest indices j₁,j₂, . . . ,j_{N} identified for each AUV, is equal to the total distance of the path generated for the plurality of AUVs;
(vi) assigning the highest indices to the corresponding AUVs if the sum of the distance travelled by the plurality of AUVs is equal to the total distance of the path, wherein the Boolean step function f(x) determines whether the path P can be divided into N parts such that each AUV travels the threshold distance from and returning to its deployment location; and
(vii) iteratively assigning waypoints to each AUV using (a) an initial index j₀=1 for the first AUV; (b) computing distance constraints to determine jᵢ for each AUV i; (c) verifying whether all waypoints are covered using the function f(x).

5. The processor-implemented method of claim 4, wherein the partition zigzag method comprises (i) performing a binary search on the boolean step function f(x) to obtain an optimal threshold distance if the sum of the highest indices identified for the plurality of AUVs is not equal to the total distance of the path generated using the pair of lines method, wherein the method performs the binary search on the f(x) to determine the minimum value of x* for which the path can be partitioned into N part; (ii) executing f(x*) to compute partition indices jᵢ and assigning final path segments to each AUV using the computed indices Pᵢ=[Sᵢ,Pⱼ_{ᵢ₋₁},Pⱼ_{ₜ₋₁}₊₁,pⱼ_{ᵢ₋₁}₊₂, . . . ,pⱼ_{ᵢ},Sᵢ], wherein each AUV travels from its starting point Sᵢ to the waypoints pⱼ_{ᵢ₋₁},pⱼ_{ᵢ₋₁}₊₁,pⱼ_{ᵢ₋₁}₊₂, . . . ,pⱼ_{ᵢ}, and returns to Sᵢ.

6. The processor-implemented method of claim 5, wherein the partition zigzag method comprises executing the boolean step function as binary search for finding the optimal threshold distance to compute optimal indices for each of the plurality of AUVs to assign respective segments to each AUV.

7. The processor-implemented of claim 3, wherein the turn-aware zigzag method iteratively assigns the segments of the path P to each AUV by,
identifying a first highest index jᵢ corresponding to a turning point pⱼ_{ᵢ} in the path P for a first AUV when a total distance travelled by the first AUV from a first starting point Sᵢ and returning to the first starting point Sᵢ is less than or equal to a threshold distance (x), wherein the first highest index is a second starting point, wherein the highest index for the AUV is a point reached by the AUV before turning to a different direction, wherein the highest index is identified by defining the function f(x) that accounts for turns in AUV trajectories;
identifying a second highest index jᵢ+1 corresponding to a turning point pⱼ_{ᵢ}₊₁ in the path P for a second AUV when the total distance travelled by the second AUV from the second starting point and returning to the second starting point is less than or equal to the threshold distance;
applying a boolean step function on the path obtained from the pair of lines method, to evaluate whether a sum of the distances travelled by the plurality of AUVs, based on the highest indices j₁,j₂, . . . ,j_{N} identified for each AUV, is equal to the total distance of the path generated for the plurality of AUVs;
assigning the highest indices to the corresponding AUVs if the sum of the distance travelled by the plurality of AUVs is equal to a total distance of the path generated, wherein the Boolean step function f(x) determines whether the path P can be divided into N parts such that each AUV travels the threshold distance from and returning to its deployment location; and
iteratively assigning waypoints to each AUV using: (a) an initial index j₀=1 for the first AUV; (b) computing distance constraints to determine jᵢ for each AUV i; (c) verifying whether all waypoints are covered using the function f(x).

8. The processor-implemented method of claim 7, wherein the turn-aware zigzag method comprises
(i) performing a binary search on the boolean step function to obtain a minimal optimal threshold distance where the sum of distance between the highest indices identified for the plurality of AUVs is not equal to the total distance of the path generated for using the pair of lines method, wherein the method performing the binary search on f(x) to determine the minimum value of x* for which the path can be partitioned into N part; and
(ii) executing f(x*) to compute partition indices jᵢ and assigning final path segments to each AUV using the computed indices Pᵢ=[Sᵢ,pⱼ_{ᵢ}₋₁,pⱼ_{ᵢ₋₁}₊₁,pⱼ_{ᵢ₋₁}₊₂, . . . ,pⱼ_{ᵢ},Sᵢ], wherein each AUV travels from its starting point Sᵢ to the waypoints pⱼ_{ᵢ₋₁},pⱼ_{ᵢ₋₁}₊₁,pⱼ_{ᵢ₋₁}₊₂, . . . ,pⱼ_{ᵢ} and returns to Sᵢ.

9. The processor-implemented method of claim 8, wherein the turn-aware zigzag method comprises executing the boolean step function as binary search for finding the optimal threshold distance to compute optimal indices for each of the plurality of AUVs to assign respective segments to each AUV.

10. The processor-implemented method of claim 4, wherein the total distance travelled by each AUV is a sum of (i) a first distance that is a distance from a starting point to a first point in its assigned segment, (ii) a second distance that is a sum of distances between consecutive points within the assigned segment, and (iii) a third distance that is a distance from a last point in the segment back to the starting point.

11. The processor-implemented method of claim 1, wherein the Pair of Lines method comprises:
placing the first AUV at a specific coordinate (dS,0) of sensor's footprint of the first AUV aligns with an edge of the area of interest;
moving the first AUV in a first direction along a vertical path, enabling the sensors to capture data from a rectangular strip of the area of interest, wherein the movement creates a nadir blind zone within the strip;
turning the first AUV at a boundary of the area of interest to initiate horizontal motion in a direction perpendicular to the vertical path;
adjusting the sensor footprint of the first AUV during the horizontal motion by aligning a second footprint of the sensor overlaps with the nadir blind zone;
navigating the first AUV along a second vertical path in a reverse direction of the first vertical path to capture data from the rectangular strip that includes the nadir blind zone; and
iteratively repeating the steps of turning, adjusting, and navigating along subsequent vertical and horizontal paths in a back-and-forth pattern to shift the sensor footprint for complete coverage of the area of interest, thereby minimizing data gaps and overlaps between adjacent strips to optimize coverage efficiency.

12. The processor-implemented method of claim 4, wherein the partition zigzag method executes a linear time O(L) traversal over the waypoints of path P to evaluate the f(x) by computing:
(i) a distance from the starting position Sᵢ to the first assigned waypoint pⱼ_{ᵢ₋₁};
(ii) a summation of distances between consecutive waypoints in the assigned segment;
(iii) a distance from the last assigned waypoint pⱼ_{ᵢ} back to the starting position Sᵢ;
(iv) determining whether all waypoints are covered by verifying that j_{N}=L for the last AUV.

13. A system for generating a coverage path planning (CPP) for a plurality of Autonomous underwater vehicles (AUVs) with nadir gaps, wherein the system comprises:
a central server that comprises:
a memory that comprises a set of instructions;
a processor that executes the set of instructions and is configured to:
receive input from a user through a user device that is communicatively connected to the central server through a network, wherein the input comprises an area of interest, a count of the plurality of AUVs, a respective starting point of the plurality of AUVs, and an operational constraint;
generate, using a pair of lines method, a path with a nadir gap based on the area of interest, wherein the path comprises a plurality of waypoints on a two-dimensional (2D) plane;
determine a path planning method from a plurality of path planning methods based on an operational priority and the starting point of the plurality of AUVs;
generate the CPP for the plurality of AUVs by dividing the path into a plurality of segments by applying the determined path planning method on the path based on the starting point of the plurality of AUVs, thereby each segment is assigned to each AUV; and
transmit the generated CPP to the plurality of AUVs that are communicatively connected to the central server through the network.
